(19) United States
(12) Patent Application Publication
(10) Pub. No.: US 2006/0029744 A1
(43) Pub. Date: Feb. 9, 2006

(54) Method of making an energetic beam markable

(76) Inventors: Gene Kim, Plantation, FL (US); Scott G. Potter, Coconut Creek, FL (US); Robert W. Pennisi, Boca Raton, FL (US)

Correspondence Address: MOTOROLA INC, 600 NORTH US HIGHWAY 45, ROOM AS437, LIBERTYVILLE, IL, 60048-5343, US

(21) Appl. No.: 11/238,302

(22) Filed: Sep. 29, 2005

Related U.S. Application Data
(62) Division of application No. 10/712,173, filed on Nov. 13, 2003.

(51) Int. Cl. B05D 3/00; B05D 3/12; B05D 1/02; B05D 7/00

(52) U.S. Cl. 427/532; 427/242; 427/421.1; 427/212

(57) ABSTRACT

A method of making an energetic beam markable appliqués (502) includes dispersing a plurality of bodies (110) of a first heat coalescable material within a second material (114) to form a plural phase material (108), coating a substrate (104) with the plural phase material (108) to form a coating of the plural phase material, and patternwise irradiating the coating of the plural phase material.

### CROSS REFERENCE TO RELATED APPLICATIONS

This application is a divisional of pending U.S. application Ser. No. 10/712,173 filed Nov. 13, 2003, and assigned to Motorola, Inc., from which priority is hereby claimed under 35 U.S.C. § 120.

### BACKGROUND OF THE INVENTION

1. Field of the Invention

The present invention relates in general to an energetic beam markable sheet on which information and graphics may be written.

2. Description of Related Art

In the last decade the number of people using portable electronic devices such as cellular telephones, and personal digital assistants has greatly increased. Such devices are often prominently displayed by their owners, such as when they are carried on belt clips or taken in hand during use. People have come to take for granted the functionality of such devices, and now also have higher expectations as to their aesthetic appeal. Manufactures have endeavored to meet these expectations by employing previously unused decoration techniques for decorating the housings of the devices. Among these newly utilized decoration techniques for portable device housings are laser etching, and in-mold decoration.

In-mold decoration typically involves printing graphics on a self supporting polymeric film, cutting the polymeric film to form appliqués of predetermined shape, optionally forming (e.g., by vacuum, pressure, and or heating) the appliqués to conform to the shape of an injection molded part that is to be made, placing the appliqué in an injection molding mold, and injecting plastic into the mold to form a molded part that has the appliqué (including printing) attached to its surface. Optionally a second polymeric film can be laminated over the printing in order to protect the printing. The printing can be conducted using a roll-to-roll printing set up. In-mold decoration provides facilitates customization by allowing graphics printed on a housing to be changed by changing to a different preprinted in-mold decoration film.

Laser etching decoration typically involves coating an inside surface of a transparent housing part with a laser etchable coating and subsequently using a computer directed laser beam to etch the coating according to a previously stored pattern. The laser etching exposes the transparent housing part and a second coating that has a color that is different from the laser etchable coating is then applied over the laser etchable coating and is visible through the openings etched in the laser etchable coating. Laser etching decoration can be used to mark the housing part with graphics or information. Laser etching decoration also facilitates customization by allowing different graphic patterns to be formed by changing the stored pattern according to which the etching laser is controlled.

### BRIEF DESCRIPTION OF THE FIGURES

The present invention will be described by way of exemplary embodiments, but not limitations, illustrated in the accompanying drawings in which like references denote similar elements, and in which:

FIG. 1 is a cross-sectional view of a first energetic beam markable in-mold decoration appliqué;

FIG. 2 is a cross-sectional view of a second energetic beam markable in-mold decoration appliqué;

FIG. 3 is a cross-sectional view of a third energetic beam markable in-mold decoration appliqué;

FIG. 4 is a cross-sectional view of a fourth energetic beam markable in-mold decoration appliqué; and

FIG. 5 is a front view of an injection molded cellular telephone housing part including an in-mold decoration appliqué.

### DETAILED DESCRIPTION OF THE PREFERRED EMBODIMENTS

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

FIG. 1 is a cross-sectional view of a first energetic beam markable in-mold decoration appliqué 100. The first appliqué 100 comprises a first substrate 102, and a second substrate 104 that are seal together along their peripheral edges 106. The peripheral edges 106 can be sealed together using an adhesive (e.g. silicone based) or without an adhesive using heat, pressure, ultrasonic welding or a combination thereof. The two substrates 102, 104 comprise thermoplastic films such as polycarbonate, poly (ethylene terephthalate), or poly (butylene terephthalate). The two substrates 102, 104 enclose a first energetic beam responsive layer 108. In the first appliqué 100, the energetic beam responsive layer 108 comprises polymeric particles 110, and larger bodies of polymer 112 that are formed from the polymeric particles 110 within a continuous phase 114. The polymeric particles suitably include poly (methacrylate), poly (vinyl acetate), styrene-butadiene-acrylonitrile copolymers. The continuous phase 114 comprises a gel or alternatively a liquid. The polymeric particles 110 are dispersed within the continuous phase 114. In the case of a gel continuous phase 114, a gel made from water and gelatin or sodium polyacrylate is suitable. Initially the polymeric particles 110 are smaller than the lowest wavelength of visible light (400 nanometers), however the polymeric particles 110 are thermally coalescable. By directed an energetic beam at a portion of the energetic beam responsive layer 108, the polymeric particles 110 are caused to coalesce forming the larger bodies 112. As the polymeric particles 110 coalesce and the size of the coalesced bodies 112 grows e.g., to a size in the range of visible light wavelengths, the coalesced bodies 112 become visible. One or both of the two substrates 102, 104 is transparent allowing changes in the layer 108 to be seen. By patternwise scanning of an energetic beam over the appliqué 100, in certain regions of the layer 108 the polymeric particles 110 are coalesced into larger bodies 112 that are visible. In the foregoing manner, the appliqué is patterned with graphics or text. In the case of a gel continuous phase 114, the power and/or scan rate of the energetic beam is suitably adjusted so that the layer 108 is heated above the glass transition temperature of the gel 114. The energetic beam is suitably controlled by a computerized controller according to a stored pattern. The energetic beam suitably comprises a laser beam or alternatively an electron beam. In the case of a laser type energetic beam, a computer can direct the laser controlling laser turning motors that are oriented by servomotors (e.g., of the galvanometer type).

In making the appliqué 100, the polymeric particles 110 are suitably prepared by microemulsion polymerization. Alternatively the polymeric particles are made by dispensing a hardenable liquid onto a spinning disk. Taylor instabilities in the flow of the liquid flowing off the disk form particles of the hardenable liquid, which then harden (e.g., due to cooling) to form the polymeric particles 110. The bichromatic polymeric particles 110 can be made dispensing two different colored hardenable liquids onto opposite sides of spinning disk.

Once the polymeric particles 110 are made, they are preferably dispersed in a liquid forming a multiphase material, i.e. a suspension of polymeric particles. In the case of a gel continuous phase 114, the suspension of polymeric particles is added to a gel forming polymer such as gelatin or sodium polyacrylate. The resulting multiphase material, e.g., suspension of polymeric particles in gel, is then suitably coated on one of the substrates 102, 104, after which the other substrate is placed over the coating of multiphase material, and the edges of the substrates 102, 104 sealed together.

A heat reflecting layer 116 is supported on an outside surface 118 of the second substrate 104. The heat reflecting layer 116 serves to reduce an amount of heat emanating from hot injected polymer, that reaches the first energetic beam responsive layer 108 when the appliqué 100 is used in an injection molding process. The heat reflecting layer 116 suitably comprises a metal such as for example a silver, and/or an inorganic material such as titanium oxide or silver oxide. The heat reflecting layer 116 alternatively comprises continuous films, or a layer comprising particles in a binder matrix. A variety of methods are suitably used to apply the heat reflection layer 116, including, but not limited vapor deposition, sputtering, and coating.

Alternatively, the continuous phase material 114 of the appliqué 110 is not used.

FIG. 2 is a cross-sectional view of a second energetic beam markable in-mold decoration appliqué 200. The second appliqué 200 includes a second energetic beam responsive layer 208 in lieu of the first energetic beam responsive layer 108 included in the first appliqué 100. The second layer 208 comprises a plurality of two color polymeric particles 210. The two color polymeric particles 210 comprise a core that is characterized by a first color, and a shell surrounding the core that is characterized by a second color. In the foregoing initial state, the shell characterized by the second color is visible. In order to develop a pattern in the second appliqué 200 an energetic beam is used to selectively irradiate the appliqué 200 according to a graphic or text pattern. The energetic beam locally heats the two color polymeric particles 210 above their melting temperature, allowing polymer and/or colorant included in the cores of the polymeric particles 210 to intermix with the shells of the polymeric particles 210 making the visible color of the polymeric particles 210 change to a third color that is a mixture between the first and second colors. Polymeric particles that have been heated by an energetic beam in order to mix the core and the shell are indicated by reference numeral 212. Patternwise exposure of the second appliqué 200 to the energetic beam causes areas that have been irradiated to appear differently (contrast) relative to areas that have not been irradiated. Additionally, irradiation of sufficient power and duration, causes the polymeric particles to coalesce into large bodies.

The polymeric particles 210 are suitably made by starting with cores made by microemulsion polymerization and coating such cores with a material characterized by the second color. Coating is suitably accomplished in a number of ways. One way to coat the cores is to allow them to rise, by the force of buoyancy, through a liquid that includes a colorant characterized by the second color. A second way to coat the cores is to electrically charge them and suspend them electrostatically while spraying them with a coating characterized by the second color. A third way to coat the cores is to tumble them down a slope while spraying them with a colored coating material. A fourth way to coat the cores is to place the cores in a solution of polymerization initiator to deposit the polymerization initiator on the cores, then dry the cores to remove excess solvent (e.g., water), then place the cores in a liquid comprising monomer, and carry out a polymerization reaction initiated by the polymerization initiator deposited on the cores thereby forming a polymeric coating on the cores. Dye may be added to the liquid comprising monomer in order to affect the color of the coating. A fifth way to coat the cores is to disperse the cores in a colored liquid that is capable of coating the cores and meter the colored liquid including the cores onto a spinning disk. Taylor instabilities in the flow of colored liquid flowing off the spinning disk forms droplets, some of which include core particles coated with the colored liquid.

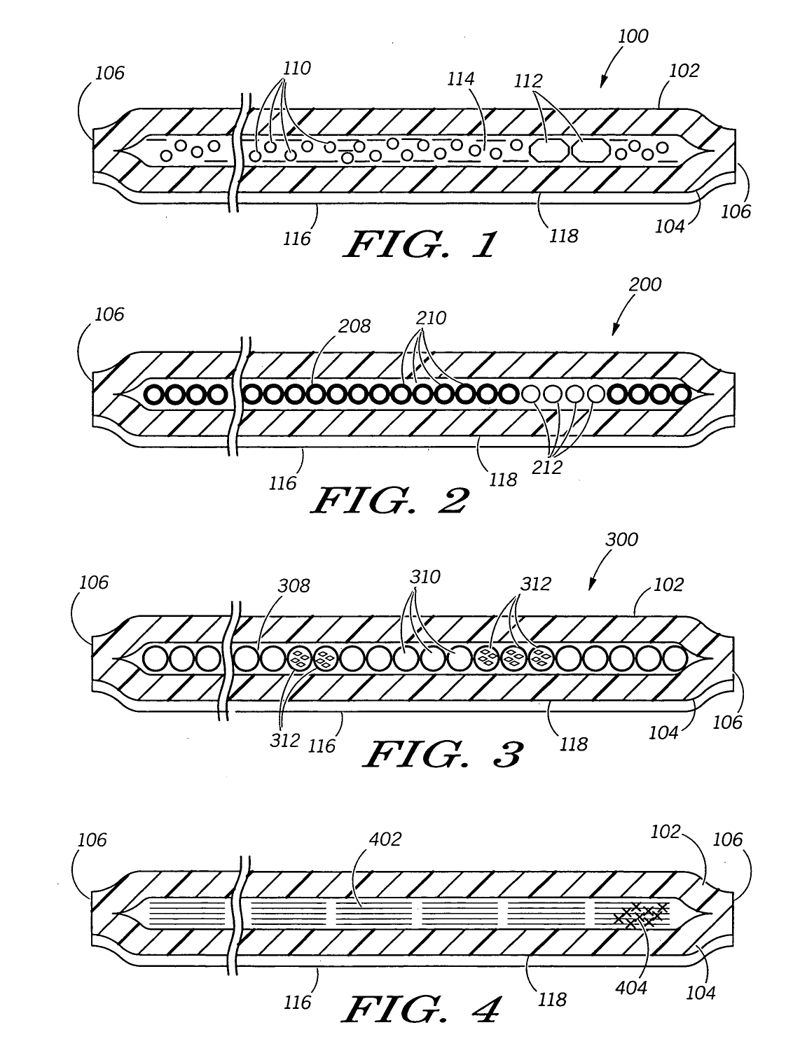

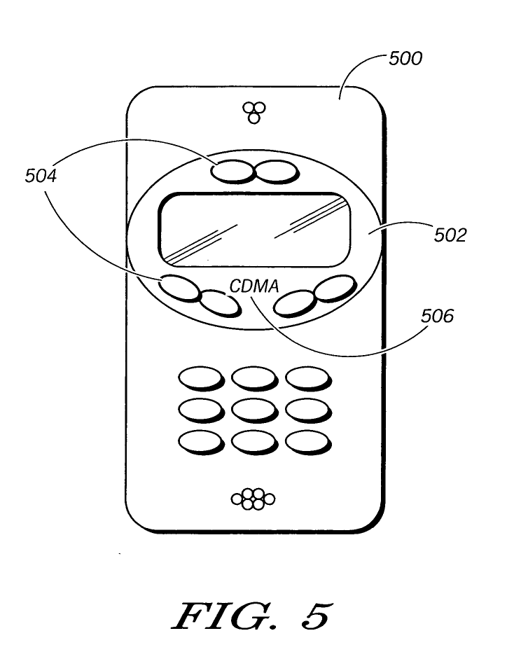

FIG. 3 is a cross-sectional view of a third energetic beam markable in-mold decoration appliqué 300. The third appliqué 300 includes a third energetic beam responsive layer 308. The third layer 308 includes a plurality of microcapsules 310. The microcapsules 310 enclose a mixture of microemulsion polymerization reactants. The mixture of microemulsion polymerization reactants includes an aqueous solvent, a quantity of emulsifier arranged in the form of micelles, a quantity of polymerization initiator, and a quantity of monomer. The monomer is thermally coalescable in that it is capable of thermally induced polymerization to form polymer particles.

In use an energetic beam irradiates the third appliqué 300 according to a predetermined pattern to form visible graphics or imprint information e.g., words. The energetic beam heats the microemulsion polymerization reactants causing the monomer to polymerize. The polymerization of the monomer changes the appearance of the microcapsules 310 that have been irradiated thereby creating a visible pattern. Microcapsules that have been irradiated with the energetic beam and consequently include polymer particles are indicated at 312.

FIG. 4 is a cross-sectional view of a fourth energetic beam markable in-mold decoration appliqué 400. The fourth appliqué 400 includes an energetic beam responsive gel layer 402. The gel layer 402 comprises a network of gel forming polymer molecules held together, e.g., by hydrogen bonding, by a quantity of polymerizable monomer. The gel forming polymer is suitably poly(N-isopropylacrylamide), poly(organotriethoxysilanes), or poly(vinyl alcohol-co-vinyl acetate)/poly(acrylic acid). The polymerizable monomer is suitably styrene, methacrylate, vinyl acetate, butadiene, or acrylonitriles.

A polymer gel that comprises partially hydrolyzed poly(vinyl alcohol-co-vinyl acetate)/poly(acrylic acid) is suitably prepared by mixing together poly(vinyl alcohol-co-vinyl acetate) and poly(acrylic acid) followed by dehydration, and light crosslinking. The cross linked mixture is put in contact, e.g., by submersion in a solution, with a quantity of using vinyl acetate monomer. The vinyl acetate monomer absorbs into the polymer gel forming a material suitable for use as gel layer 402.

In use an energetic beam irradiates the gel layer 402 according to a predetermined pattern. The areas of the gel layer 402 that are irradiated by the energetic beam become heated above the sol-gel transition temperature of the gel layer 402 causing the monomer to polymerize and locally changing the appearance of the appliqué 400. A region of the layer 402 that has been irradiated so as to cause the monomer to polymerize is indicated at 404.

FIG. 5 is a front view of an injection molded cellular telephone housing part 500 including an in-mold decoration appliqué 502. The appliqué 502 is of one of the types shown in FIGS. 1-4. The housing part 500 is formed by placing the appliqué 502 in an injection molding mold, and injecting polymer into the mold. In injecting polymer into the mold, the appliqué 502 becomes fused to the housing part 500, as the housing part 500 is formed. The appliqué 502 includes decorative patterns 504, and text 506 formed by patternwise irradiating the appliqué 502 with an energetic beam as described above.

As used in the present description the term ‘energetic beam’ encompasses laser beams, such as infrared, visible, and ultraviolet laser beams, and charge particle beams such as electron beams. As used in the present description the term polymeric particles means particles that comprise one or more polymer constituents.

While the preferred and other embodiments of the invention have been illustrated and described, it will be clear that the invention is not so limited. Numerous modifications, changes, variations, substitutions, and equivalents will occur to those of ordinary skill in the art without departing from the spirit and scope of the present invention as defined by the following claims.

What is claimed is:

1. A method of making an energetic beam markable article comprising:
dispersing a plurality of bodies of a first heat coalescable material within a second material to form a plural phase material;
coating a substrate with the plural phase material to form a coating of the plural phase material;
patternwise irradiating the coating of the plural phase material.

2. The method according to claim 1 wherein dispersing bodies of the first heat coalescable material within the second material comprises:
forming a suspension of a plurality of polymeric particles in a liquid; and
mixing the liquid and a gel forming polymer to form a gel.

3. The method according to claim 1 wherein:
the plural phase material comprise a gel; and
patternwise irradiating the coating of the plural phase material comprises patternwise heating of the gel above a sol-gel transition temperature of the gel.

4. The method according to claim 1 further comprising:
performing emulsion polymerization to make the plurality of bodies.

5. A method of making an energetic beam markable article comprising:
making a plurality of particle cores that are characterized by a first color;
coating the plurality of particle cores with a coating characterized by a second color; and
forming a layer of the plurality of particle cores with the coating.

6. The method according to claim 5 wherein coating the plurality of particle cores comprises:
electrostatically suspending the plurality of particle cores while spraying the plurality of particle cores with the coating material.

7. The method according to claim 5 wherein coating the plurality of particle cores comprises:
tumbling the plurality of particle cores down a slope while spraying the plurality of particle cores with the coating material.

8. The method according to claim 5 wherein coating the plurality of particle cores comprises:
placing the plurality of particle cores within a liquid that includes the coating material and in which the plurality of particle cores are buoyant;
allowing the plurality of particle cores to rise within the liquid; and
collecting the plurality of particle cores at a surface of the liquid.

9. The method according to claim 5 wherein coating the plurality of particle cores comprises:
placing the plurality of particle cores in a solution of polymerization catalyst to adsorb polymerization catalyst on the cores;
drying the cores to remove excess solvent; and
placing the cores in liquid including monomer to form a polymerized coating on the particles.

10. The method according to claim 5 wherein coating the plurality of particle cores comprises:
dispersing the plurality of particle cores in a colored liquid; and
metering the colored liquid including the plurality of particle cores onto a spinning disk, whereby Taylor instabilities in the colored liquid flowing off the spinning disk form droplets that include the plurality of particle cores coated with the colored liquid.
